(19) United States
(12) Patent Application Publication
(10) Pub. No.: US 2011/0267283 A1
(43) Pub. Date: Nov. 3, 2011

(54) Kickback Voltage Equalization

(76) Inventors: Shih Chang CHANG, San Jose, CA (US); Hopil BAE, Sunnyvale, CA (US); Cheng Ho YU, Cupertino, CA (US); Zhibing GE, Sunnyvale, CA (US)

(21) Appl. No.: 12/842,542

(22) Filed: Jul. 23, 2010

Related U.S. Application Data
(60) Provisional application No. 61/330,163, filed on Apr. 30, 2010.

(51) Int. Cl. G06F 3/041

(52) U.S. Cl. 345/173

(57) ABSTRACT

Scanning gate lines in a gate driver system of a touch screen is provided. The gate driver system can include gate lines connected to display pixel transistors, a display driver that can generate first and second gate clock signals including first and second voltage transitions, respectively, and a gate drivers that can receive the first and second gate clock signals via gate clock lines and that can apply gate line signals, based on the gate clock signals, to the gate lines. A first voltage change generated in a common electrode line of the touch screen by the first voltage transition can be reduced by a second voltage change generated in the common electrode by the second voltage transition.

### CROSS REFERENCE TO RELATED APPLICATIONS

This application claims benefit of U.S. Provisional Application No. 61/330,163 filed Apr. 30, 2010, the contents of which are incorporated by reference herein in their entirety for all purposes.

### FIELD OF THE DISCLOSURE

This relates generally to touch screens, and more particularly equalizing kickback voltage effects in touch screens.

### BACKGROUND OF THE DISCLOSURE

Many types of input devices are presently available for performing operations in a computing system, such as buttons or keys, mice, trackballs, joysticks, touch sensor panels, touch screens and the like. Touch screens, in particular, are becoming increasingly popular because of their ease and versatility of operation as well as their declining price. Touch screens can include a touch sensor panel, which can be a clear panel with a touch-sensitive surface, and a display device such as a liquid crystal display (LCD) that can be positioned partially or fully behind the panel so that the touch-sensitive surface can cover at least a portion of the viewable area of the display device. Touch screens can allow a user to perform various functions by touching the touch sensor panel using a finger, stylus or other object at a location often dictated by a user interface (UI) being displayed by the display device. In general, touch screens can recognize a touch and the position of the touch on the touch sensor panel, and the computing system can then interpret the touch in accordance with the display appearing at the time of the touch, and thereafter can perform one or more actions based on the touch. In the case of some touch sensing systems, a physical touch on the display is not needed to detect a touch. For example, in some capacitive-type touch sensing systems, fringing fields used to detect touch can extend beyond the surface of the display, and objects approaching near the surface may be detected near the surface without actually touching the surface.

Capacitive touch sensor panels can be formed from a matrix of drive and sense lines of a substantially transparent conductive material, such as Indium Tin Oxide (ITO), often arranged in rows and columns in horizontal and vertical directions on a substantially transparent substrate. It is due in part to their substantial transparency that capacitive touch sensor panels can be overlaid on a display to form a touch screen, as described above. Some touch screens can be formed by integrating touch sensing circuitry into a display pixel stackup (i.e., the stacked material layers forming the display pixels).

### SUMMARY

This relates to touch screens and to equalizing kickback voltage effects in touch screens. In some touch screen designs, an amount of kickback voltage resulting from a voltage transition of a gate line signal can vary depending on, for example, differences in voltages induced in other circuit components of the touch screen. For example, some touch screens can have parasitic capacitances between common electrode lines and gate lines. In some touch screens that can include different configurations of common electrode lines, the parasitic capacitances, and hence an amount of capacitive coupling, between various gate lines and common electrode lines can be different. As a result, the amount of kickback voltage in one region of the touch screen having one type of common electrode line can be different than another region having another type of common electrode line. The difference in kickback voltage can result in a difference in the luminance of display pixels in one region versus display pixels of the other region, which can result in a visual artifact perceptible to the human eye.

In some embodiments, the voltage difference can be reduced or eliminated by timing a second voltage transition of a second gate line signal in a different gate line to occur simultaneously or nearly simultaneously with the voltage transition of the first gate line signal. In other words, the second voltage transition can be opposing to the first voltage transition, e.g., the first transition may be a high-to-low voltage transition that switches off transistors in a first row of display pixels, and the second transition may be a low-to-high voltage transition that switches on transistors in a second row of display pixels.

### BRIEF DESCRIPTION OF THE DRAWINGS

FIGS. 1A-1C illustrate an example mobile telephone, an example media player, and an example personal computer that each include an example touch screen according to embodiments of the disclosure.

FIG. 2 is a block diagram of an example computing system that illustrates one implementation of an example touch screen according to embodiments of the disclosure.

FIG. 3 is a more detailed view of the touch screen of FIG. 2 showing an example configuration of drive lines and sense lines according to embodiments of the disclosure.

FIG. 4 illustrates an example configuration in which touch sensing circuitry includes common electrodes (Vcom) according to embodiments of the disclosure.

FIG. 5 illustrates an exploded view of display pixel stackups according to embodiments of the disclosure.

FIG. 6 illustrates an example touch sensing operation according to embodiments of the disclosure.

FIG. 7 illustrates an example single-sided gate driver configuration according to embodiments of the disclosure.

FIG. 8 illustrates example gate clock signals according to embodiments of the disclosure.

FIG. 9 illustrates a partial circuit diagram of an example display pixel according to embodiments of the disclosure.

FIG. 10 illustrates an example configuration of horizontal and vertical Vcom lines according to embodiments of the disclosure.

FIG. 11 illustrates a partial circuit diagram of example display pixels according to embodiments of the disclosure.

FIG. 12 illustrates example gate clock signals according to embodiments of the disclosure.

FIG. 13 illustrates an example double-sided gate driver configuration according to embodiments of the disclosure.

FIG. 14 illustrates example gate clock signals according to embodiments of the disclosure.

FIG. 15 illustrates an example method of selecting gate clock signals with fixed intervals according to embodiments of the disclosure.

FIG. 16 illustrates an example method of selecting gate clock signals in a frame dithering configuration according to embodiments of the disclosure.

FIG. 17 illustrates an example method of selecting gate clock signals in a line dithering configuration according to embodiments of the disclosure.

### DETAILED DESCRIPTION

In the following description of example embodiments, reference is made to the accompanying drawings which form a part hereof, and in which it is shown by way of illustration specific embodiments in which embodiments of the disclosure can be practiced. It is to be understood that other embodiments can be used and structural changes can be made without departing from the scope of the embodiments of this disclosure.

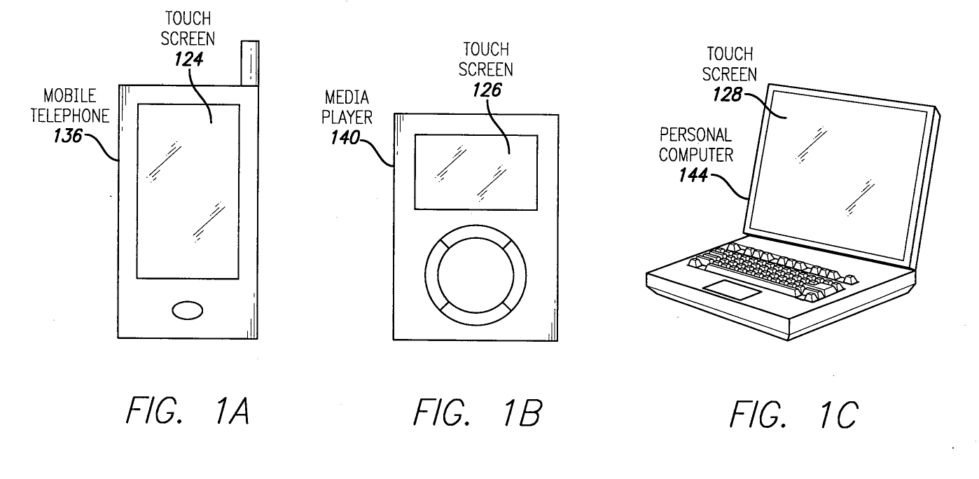

FIGS. 1A-1C show example systems in which a touch screen according to embodiments of the disclosure may be implemented. FIG. 1A illustrates an example mobile telephone 136 that includes a touch screen 124. FIG. 1B illustrates an example digital media player 140 that includes a touch screen 126. FIG. 1C illustrates an example personal computer 144 that includes a touch screen 128. Touch screens 124, 126, and 128 may be based on, for example, self capacitance or mutual capacitance, or another touch sensing technology in which effects of parasitic capacitances can be equalized. For example, in a self capacitance based touch system, an individual electrode with a self-capacitance to ground can be used to form a touch pixel for detecting touch. As an object approaches the touch pixel, an additional capacitance to ground can be formed between the object and the touch pixel. The additional capacitance to ground can result in a net increase in the self-capacitance seen by the touch pixel. This increase in self-capacitance can be detected and measured by a touch sensing system to determine the positions of multiple objects when they touch the touch screen. A mutual capacitance based touch system can include, for example, drive regions and sense regions, such as drive lines and sense lines. For example, drive lines can be formed in rows while sense lines can be formed in columns (e.g., orthogonal). Touch pixels can be formed at the intersections of the rows and columns. During operation, the rows can be stimulated with an AC waveform and a mutual capacitance can be formed between the row and the column of the touch pixel. As an object approaches the touch pixel, some of the charge being coupled between the row and column of the touch pixel can instead be coupled onto the object. This reduction in charge coupling across the touch pixel can result in a net decrease in the mutual capacitance between the row and the column and a reduction in the AC waveform being coupled across the touch pixel. This reduction in the charge-coupled AC waveform can be detected and measured by the touch sensing system to determine the positions of multiple objects when they touch the touch screen. In some embodiments, a touch screen can be multi-touch, single touch, projection scan, full-imaging multi-touch, or any capacitive touch.

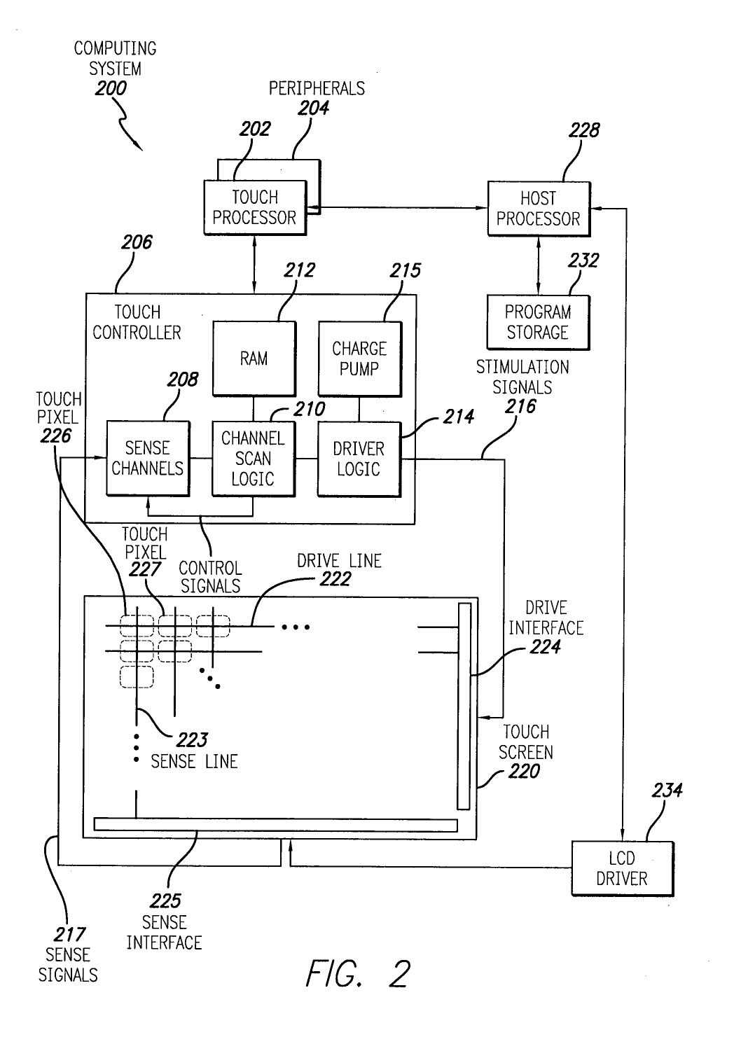

FIG. 2 is a block diagram of an example computing system 200 that illustrates one implementation of an example touch screen 220 according to embodiments of the disclosure. Computing system 200 could be included in, for example, mobile telephone 136, digital media player 140, personal computer 144, or any mobile or non-mobile computing device that includes a touch screen. Computing system 200 can include a touch sensing system including one or more touch processors 202, peripherals 204, a touch controller 206, and touch sensing circuitry (described in more detail below). Peripherals 204 can include, but are not limited to, random access memory (RAM) or other types of memory or storage, watchdog timers and the like. Touch controller 206 can include, but is not limited to, one or more sense channels 208, channel scan logic 210 and driver logic 214. Channel scan logic 210 can access RAM 212, autonomously read data from the sense channels and provide control for the sense channels. In addition, channel scan logic 210 can control driver logic 214 to generate stimulation signals 216 at various frequencies and phases that can be selectively applied to drive regions of the touch sensing circuitry of touch screen 220, as described in more detail below. In some embodiments, touch controller 206, touch processor 202 and peripherals 204 can be integrated into a single application specific integrated circuit (ASIC).

Computing system 200 can also include a host processor 228 for receiving outputs from touch processor 202 and performing actions based on the outputs. For example, host processor 228 can be connected to program storage 232 and a display controller, such as an LCD driver 234. Host processor 228 can use LCD driver 234 to generate an image on touch screen 220, such as an image of a user interface (UI), and can use touch processor 202 and touch controller 206 to detect a touch on or near touch screen 220, such a touch input to the displayed UI. The touch input can be used by computer programs stored in program storage 232 to perform actions that can include, but are not limited to, moving an object such as a cursor or pointer, scrolling or panning, adjusting control settings, opening a file or document, viewing a menu, making a selection, executing instructions, operating a peripheral device connected to the host device, answering a telephone call, placing a telephone call, terminating a telephone call, changing the volume or audio settings, storing information related to telephone communications such as addresses, frequently dialed numbers, received calls, missed calls, logging onto a computer or a computer network, permitting authorized individuals access to restricted areas of the computer or computer network, loading a user profile associated with a user's preferred arrangement of the computer desktop, permitting access to web content, launching a particular program, encrypting or decoding a message, and/or the like. Host processor 228 can also perform additional functions that may not be related to touch processing.

Touch screen 220 can include touch sensing circuitry that can include a capacitive sensing medium having a plurality of drive lines 222 and a plurality of sense lines 223. It should be noted that the term “lines” is sometimes used herein to mean simply conductive pathways, as one skilled in the art will readily understand, and is not limited to elements that are strictly linear, but includes pathways that change direction, and includes pathways of different size, shape, materials, etc. Drive lines 222 can be driven by stimulation signals 216 from driver logic 214 through a drive interface 224, and resulting sense signals 217 generated in sense lines 223 can be transmitted through a sense interface 225 to sense channels 208 (also referred to as an event detection and demodulation circuit) in touch controller 206. In this way, drive lines and sense lines can be part of the touch sensing circuitry that can interact to form capacitive sensing nodes, which can be thought of as touch picture elements (touch pixels), such as touch pixels 226 and 227. This way of understanding can be particularly useful when touch screen 220 is viewed as capturing an “image” of touch. In other words, after touch controller 206 has determined whether a touch has been detected at each touch pixel in the touch screen, the pattern of touch pixels in the touch screen at which a touch occurred can be thought of as an “image” of touch (e.g. a pattern of fingers touching the touch screen).

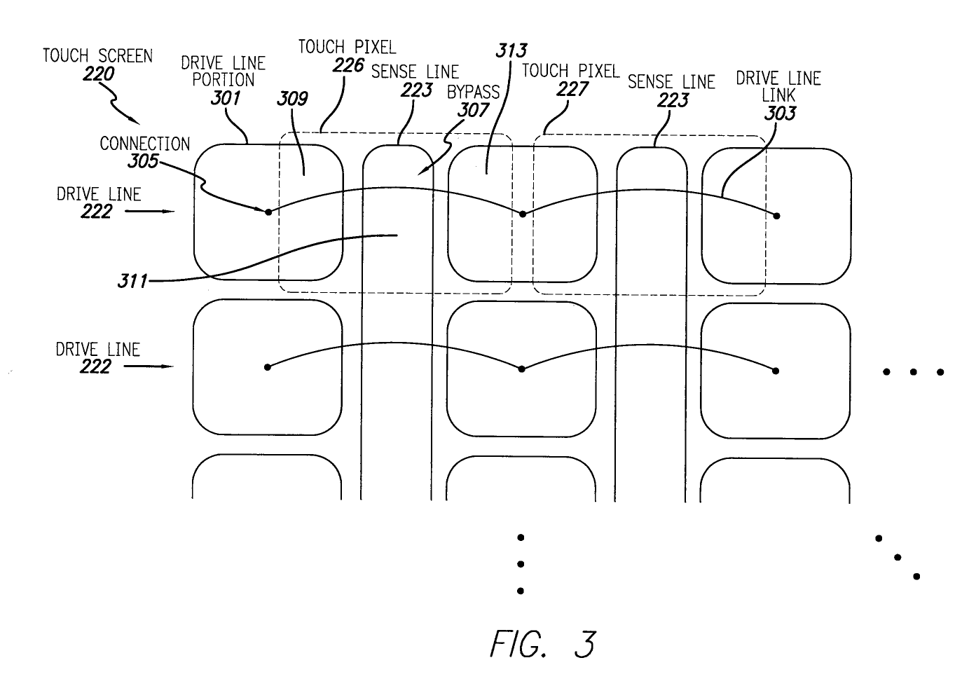

In some example embodiments, touch screen 220 can be an integrated touch screen in which touch sensing circuit elements of the touch sensing system can be integrated into the display pixels stackups of a display. An example integrated touch screen in which embodiments of the disclosure can be implemented with now be described with reference to FIGS. 3-6. FIG. 3 is a more detailed view of touch screen 220 showing an example configuration of drive lines 222 and sense lines 223 according to embodiments of the disclosure. As shown in FIG. 3, each drive line 222 can be formed of one or more drive line segments 301 that can be electrically connected by drive line links 303 at connections 305. Drive line links 303 are not electrically connected to sense lines 223, rather, the drive line links can bypass the sense lines through bypasses 307. Drive lines 222 and sense lines 223 can interact capacitively to form touch pixels such as touch pixels 226 and 227. Drive lines 222 (i.e., drive line segments 301 and corresponding drive line links 303) and sense lines 223 can be formed of electrical circuit elements in touch screen 220. In the example configuration of FIG. 3, each of touch pixels 226 and 227 can include a portion of one drive line segment 301, a portion of a sense line 223, and a portion of another drive line segment 301. For example, touch pixel 226 can include a right-half portion 309 of a drive line segment on one side of a portion 311 of a sense line, and a left-half portion 313 of a drive line segment on the opposite side of portion 311 of the sense line.

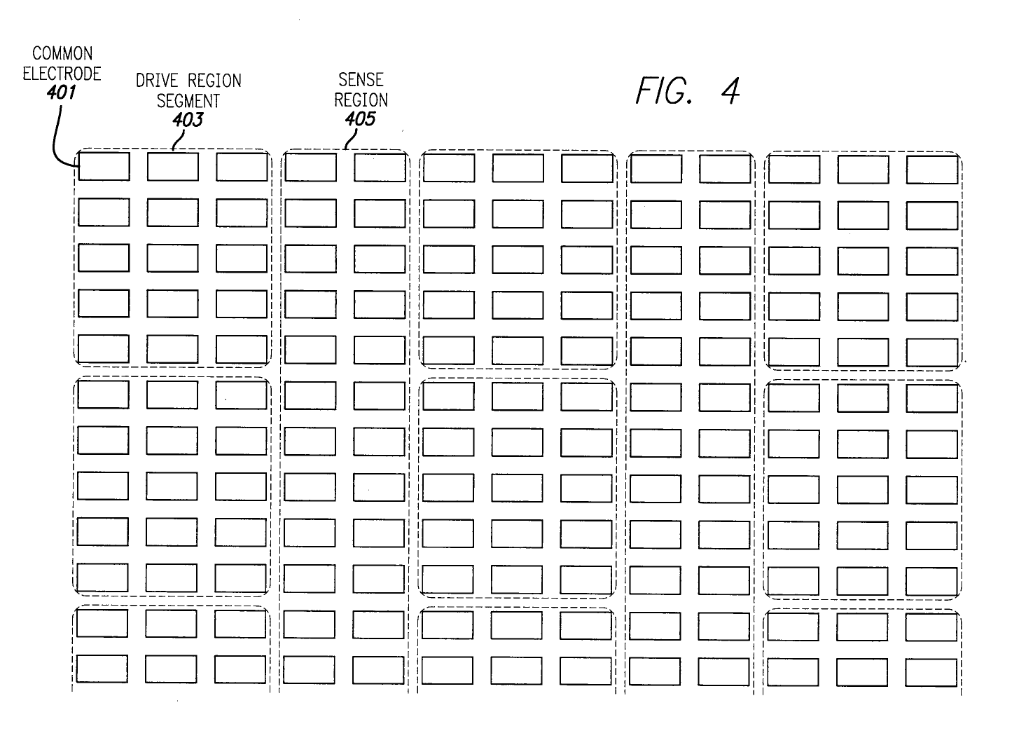

The circuit elements can include, for example, elements that can exist in conventional LCD displays, as described above. It is noted that circuit elements are not limited to whole circuit components, such a whole capacitor, a whole transistor, etc., but can include portions of circuitry, such as only one of the two plates of a parallel plate capacitor. FIG. 4 illustrates an example configuration in which common electrodes (Vcom) can form portions of the touch sensing circuitry of a touch sensing system. Each display pixel includes a common electrode 401, which is a circuit element of the display system circuitry in the pixel stackup (i.e., the stacked material layers forming the display pixels) of the display pixels of some types of conventional LCD displays, e.g., fringe field switching (FFS) displays, that can operate as part of the display system to display an image.

In the example shown in FIG. 4, each common electrode (Vcom) 401 can serve as a multi-function circuit element that can operate as display circuitry of the display system of touch screen 220 and can also operate as touch sensing circuitry of the touch sensing system. In this example, each common electrode 401 can operate as a common electrode of the display circuitry of the touch screen, and can also operate together when grouped with other common electrodes as touch sensing circuitry of the touch screen. For example, a group of common electrodes 401 can operate together as a capacitive part of a drive line or a sense line of the touch sensing circuitry during the touch sensing phase. Other circuit elements of touch screen 220 can form part of the touch sensing circuitry by, for example, electrically connecting together common electrodes 401 of a region, switching electrical connections, etc. In general, each of the touch sensing circuit elements may be either a multi-function circuit element that can form part of the touch sensing circuitry and can perform one or more other functions, such as forming part of the display circuitry, or may be a single-function circuit element that can operate as touch sensing circuitry only. Similarly, each of the display circuit elements may be either a multi-function circuit element that can operate as display circuitry and perform one or more other functions, such as operating as touch sensing circuitry, or may be a single-function circuit element that can operate as display circuitry only. Therefore, in some embodiments, some of the circuit elements in the display pixel stackups can be multi-function circuit elements and other circuit elements may be single-function circuit elements. In other embodiments, all of the circuit elements of the display pixel stackups may be single-function circuit elements.

In addition, although example embodiments herein may describe the display circuitry as operating during a display phase, and describe the touch sensing circuitry as operating during a touch sensing phase, it should be understood that a display phase and a touch sensing phase may be operated at the same time, e.g., partially or completely overlap, or the display phase and touch phase may operate at different times. Also, although example embodiments herein describe certain circuit elements as being multi-function and other circuit elements as being single-function, it should be understood that the circuit elements are not limited to the particular functionality in other embodiments. In other words, a circuit element that is described in one example embodiment herein as a single-function circuit element may be configured as a multi-function circuit element in other embodiments, and vice versa.

For example, FIG. 4 shows common electrodes 401 grouped together to form drive region segments 403 and sense regions 405 that generally correspond to drive line segments 301 and sense lines 223, respectively. Grouping multi-function circuit elements of display pixels into a region can mean operating the multi-function circuit elements of the display pixels together to perform a common function of the region. Grouping into functional regions may be accomplished through one or a combination of approaches, for example, the structural configuration of the system (e.g., physical breaks and bypasses, voltage line configurations), the operational configuration of the system (e.g., switching circuit elements on/off, changing voltage levels and/or signals on voltage lines), etc.

Multi-function circuit elements of display pixels of the touch screen can operate in both the display phase and the touch phase. For example, during a touch phase, common electrodes 401 can be grouped together to form touch signal lines, such as drive regions and sense regions. In some embodiments circuit elements can be grouped to form a continuous touch signal line of one type and a segmented touch signal line of another type. For example, FIG. 4 shows one example embodiment in which drive region segments 403 and sense regions 405 correspond to drive line segments 301 and sense lines 223 of touch screen 220. Other configurations are possible in other embodiments, for example, common electrodes 401 could be grouped together such that drive lines are each formed of a continuous drive region and sense lines are each formed of a plurality of sense region segments linked together through connections that bypass a drive region.

The drive regions in the example of FIG. 3 are shown in FIG. 4 as rectangular regions including a plurality of common electrodes of display pixels, and the sense regions of FIG. 3 are shown in FIG. 4 as rectangular regions including a plurality of common electrodes of display pixels extending the vertical length of the LCD. In some embodiments, a touch pixel of the configuration of FIG. 4 can include, for example, a 64×64 area of display pixels. However, the drive and sense regions are not limited to the shapes, orientations, and positions shown, but can include any suitable configurations according to embodiments of the disclosure. It is to be understood that the display pixels used to form the touch pixels are not limited to those described above, but can be any suitable size or shape to permit touch capabilities according to embodiments of the disclosure.

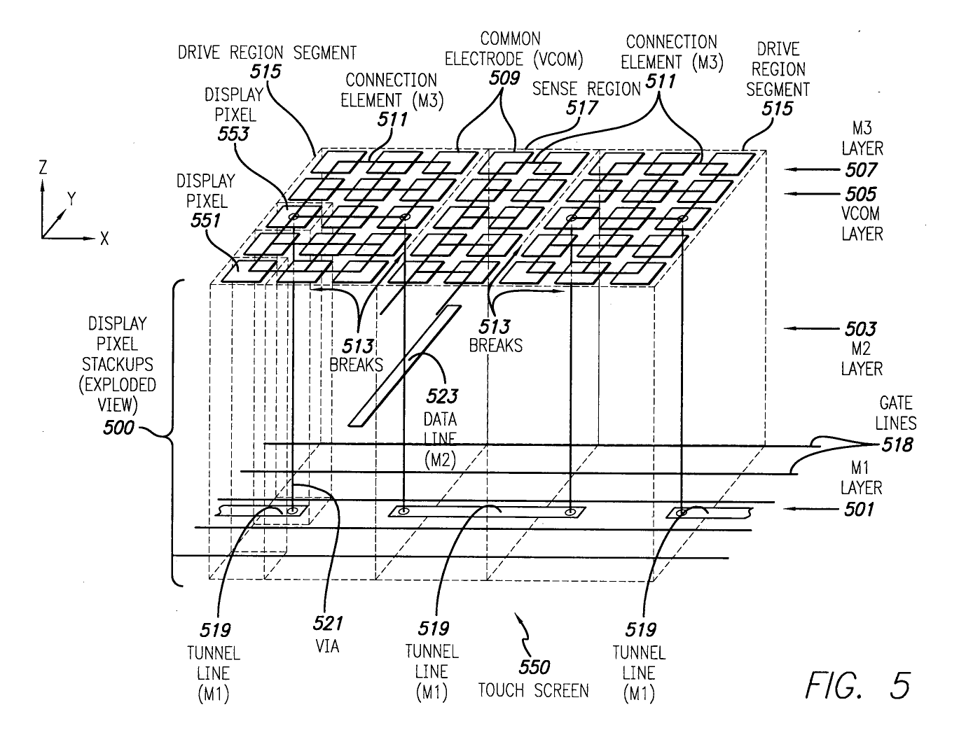

FIG. 5 is a three-dimensional illustration of an exploded view (expanded in the z-direction) of example display pixel stackups 500 showing some of the elements within the pixel stackups of an example integrated touch screen 550. Stackups 500 can include a configuration of conductive lines that can be used to group common electrodes, such as common electrodes 401, into drive region segments and sense regions, such as shown in FIG. 4, and to link drive region segments to form drive lines.

Stackups 500 can include elements in a first metal (M1) layer 501, a second metal (M2) layer 503, a common electrode (Vcom) layer 505, and a third metal (M3) layer 507. Each display pixel can include a common electrode 509, such as common electrodes 401 in FIG. 4, that is formed in Vcom layer 505. M3 layer 507 can include connection element 511 that can electrically connect together common electrodes 509. In some display pixels, breaks 513 can be included in connection element 511 to separate different groups of common electrodes 509 to form drive region segments 515 and a sense region 517, such as drive region segments 403 and sense region 405, respectively. Breaks 513 can include breaks in the x-direction that can separate drive region segments 515 from sense region 517, and breaks in the y-direction that can separate one drive region segment 515 from another drive region segment. M1 layer 501 can include gate lines 518. M1 layer 501 can include tunnel lines 519 that can electrically connect together drive region segments 515 through connections, such as conductive vias 521, which can electrically connect tunnel line 519 to the grouped common electrodes in drive region segment display pixels. Tunnel line 519 can run through the display pixels in sense region 517 with no connections to the grouped common electrodes in the sense region, e.g., no vias 521 in the sense region. M2 layer 503 can include data lines 523. Only one data line 523 is shown for the sake of clarity; however, a touch screen can include multiple data lines running through each vertical row of pixels, for example, one data line for each red, green, blue (RGB) color sub-pixel in each pixel in a vertical row of an RGB display integrated touch screen.

Structures such as connection elements 511, tunnel lines 519, and conductive vias 521 can operate as a touch sensing circuitry of a touch sensing system to detect touch during a touch sensing phase of the touch screen. Structures such as data lines 523, along with other pixel stackup elements such as transistors, pixel electrodes, common voltage lines, data lines, etc. (not shown), can operate as display circuitry of a display system to display an image on the touch screen during a display phase. Structures such as common electrodes 509 can operate as multifunction circuit elements that can operate as part of both the touch sensing system and the display system.

For example, in operation during a touch sensing phase, stimulation signals can be transmitted through a row of drive region segments 515 connected by tunnel lines 519 and conductive vias 521 to form electric fields between the stimulated drive region segments and sense region 517 to create touch pixels, such as touch pixel 226 in FIG. 2. In this way, the row of connected together drive region segments 515 can operate as a drive line, such as drive line 222, and sense region 517 can operate as a sense line, such as sense line 223. When an object such as a finger approaches or touches a touch pixel, the object can affect the electric fields extending between the drive region segments 515 and the sense region 517, thereby reducing the amount of charge capacitively coupled to the sense region. This reduction in charge can be sensed by a sense channel of a touch sensing controller connected to the touch screen, such as touch controller 206 shown in FIG. 2, and stored in a memory along with similar information of other touch pixels to create an “image” of touch.

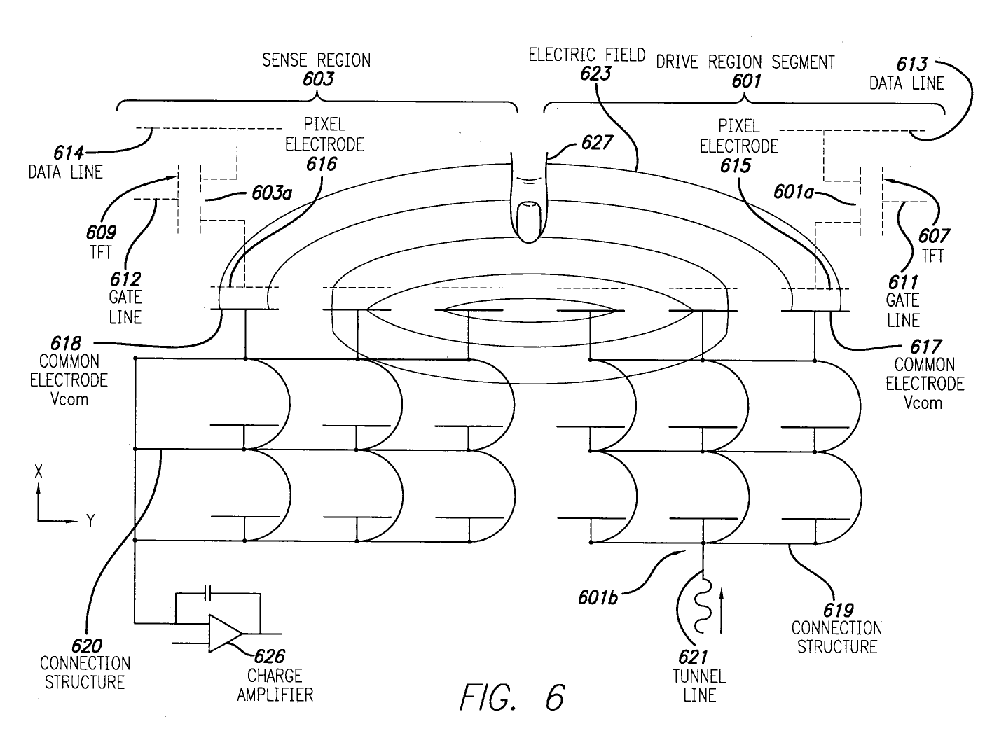

A touch sensing operation according to embodiments of the disclosure will be described with reference to FIG. 6. FIG. 6 shows partial circuit diagrams of some of the touch sensing circuitry within display pixels in a drive region segment 601 and a sense region 603 of an example touch screen according to embodiments of the disclosure. For the sake of clarity, only one drive region segment is shown. Also for the sake of clarity, FIG. 6 includes circuit elements illustrated with dashed lines to signify some circuit elements operate primarily as part of the display circuitry and not the touch sensing circuitry. In addition, a touch sensing operation is described primarily in terms of a single display pixel 601a of drive region segment 601 and a single display pixel 603a of sense region 603. However, it is understood that other display pixels in drive region segment 601 can include the same touch sensing circuitry as described below for display pixel 601a, and the other display pixels in sense region 603 can include the same touch sensing circuitry as described below for display pixel 603a. Thus, the description of the operation of display pixel 601a and display pixel 603a can be considered as a description of the operation of drive region segment 601 and sense region 603, respectively.

Referring to FIG. 6, drive region segment 601 includes a plurality of display pixels including display pixel 601a. Display pixel 601a can include a TFT 607, a gate line 611, a data line 613, a pixel electrode 615, and a common electrode 617. FIG. 6 shows common electrode 617 connected to the common electrodes in other display pixels in drive region segment 601 through a connection element 619 within the display pixels of drive region segment 601 that is used for touch sensing as described in more detail below. Sense region 603 includes a plurality of display pixels including display pixel 603a. Display pixel 603a includes a TFT 609, a gate line 612, a data line 614, a pixel electrode 616, and a common electrode 618. FIG. 6 shows common electrode 618 connected to the common electrodes in other display pixels in sense region 603 through a connection element 620 that can be connected, for example, in a border region of the touch screen to form an element within the display pixels of sense region 603 that is used for touch sensing as described in more detail below.

During a touch sensing phase, drive signals can be applied to common electrodes 617 through a tunnel line 621 that is electrically connected to a portion of connection element 619 within a display pixel 601b of drive region segment 601. The drive signals, which are transmitted to all common electrodes 617 of the display pixels in drive region segment 601 through connection element 619, can generate an electrical field 623 between the common electrodes of the drive region segment and common electrodes 618 of sense region 603, which can be connected to a sense amplifier, such as a charge amplifier 626. Electrical charge can be injected into the structure of connected common electrodes of sense region 603, and charge amplifier 626 converts the injected charge into a voltage that can be measured. The amount of charge injected, and consequently the measured voltage, can depend on the proximity of a touch object, such as a finger 627, to the drive and sense regions. In this way, the measured voltage can provide an indication of touch on or near the touch screen.

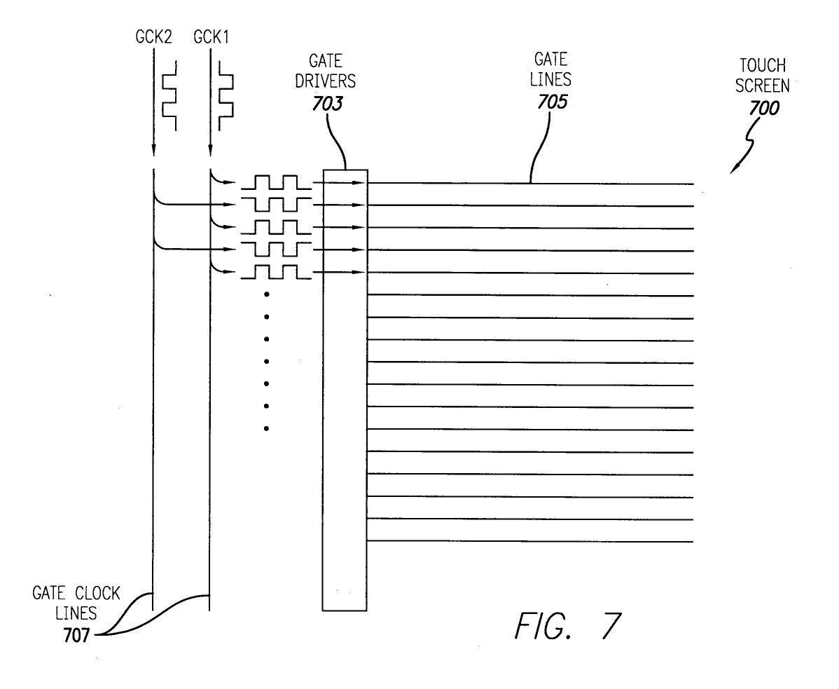

In a display phase of operation an image can be displayed on the touch screen by, for example, switching on transistors in one row of the touch screen using gate clock signals to generate gate signals on the gate lines while pixel voltages for the row of pixels can be applied to the corresponding data lines. FIG. 7 illustrates an example configuration of gate drivers and gate lines according to embodiments of the disclosure. A touch screen 700 can include gate drivers 703 and gate lines 705. Gate drivers 703 can be positioned along the left border of touch screen 700. Gate drivers 703 can be driven by gate clock signals on gate clock lines 707, including first and second gate clock signals (GCK1 and GCK2). Shift registers (not shown) can be used to apply the gate clock signals sequentially to gate drivers 703, which can apply gate signals to the gate lines 705, such that a gate signal based on the first gate clock signal (GCK1) can be applied to a first gate line. The first gate signal can include a low-to-high voltage transition, for example, that switches the display pixel transistors in the row from an off state to an on state. Once the first row of pixels is switched on, data signals can be applied to the data lines to charge the pixel electrodes in the first row of display pixels to the appropriate voltages. In some embodiments, for example, each display pixel can include three transistors, each connected to one of three data lines corresponding to red, green, and blue (RGB) subpixels. After the pixel electrodes are charged, GCK1 can switch off the transistors in the row of display pixels with a high-to-low transition. A gate signal based on the second gate clock signal (GCK2) can be applied to the second gate line, such that when the first gate line is switched off, the second gate line is switched on with a low-to-high transition of GCK2. Data signals corresponding to the second row of display pixels can be applied to the data lines, and GCK2 can transition from the high voltage to the low voltage to switch off the transistors in the second row of display pixels. The process can then repeat for each gate line 705 to scan the rows of display pixels, e.g., sequentially switch on and update each row of display pixels with new display information, based on the timing of the low-to-high and high-to-low transitions of the two gate clock signals GCK1 and GCK2.

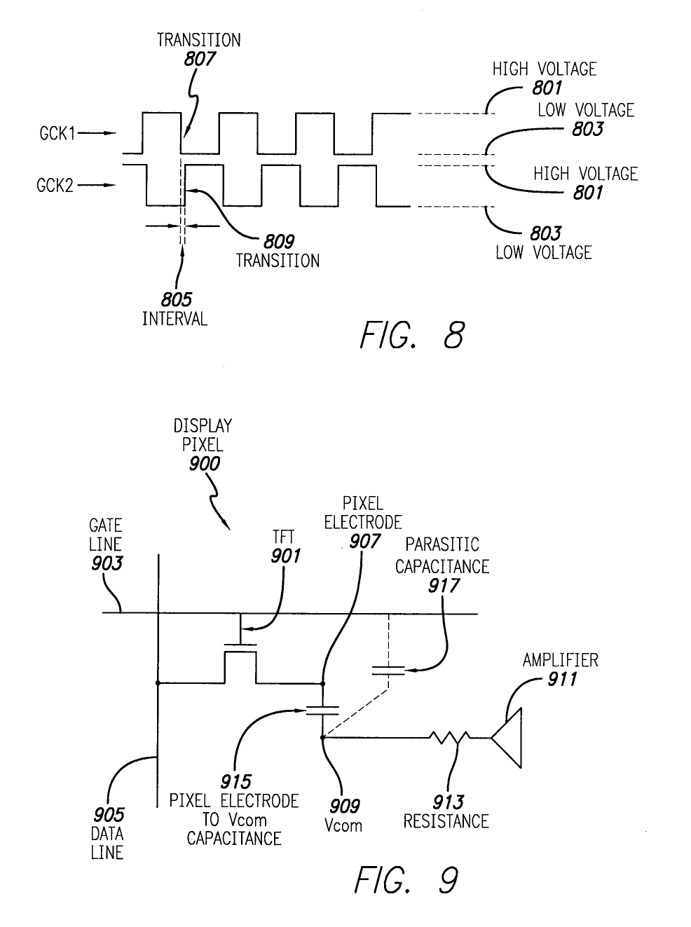

FIG. 8 illustrates example gate clock signals GCK1 and GCK2 according to various embodiments. Each of GCK1 and GCK2 can include a high voltage 801 and a low voltage 803. An interval 805 can exist between a transition 807 from the high voltage to the low voltage in GCK1 and a transition 809 from the low voltage to the high voltage in GCK2. In other words, after one gate line is switched off with transition 807 of GCK1, there can be a delay before transition 809 of GCK2 switches the next gate line on. In some designs, a delay between a falling gate clock signal (i.e., a high-to-low transition) of one line and a rising gate clock signal (i.e., a low-to-high transition) of a next line can provide, for example, reduced power consumption of the display. Interval 805 may be, for example, approximately 0.25 microseconds in some embodiments.

As one skilled in the art would understand, other configurations of gate lines and gate clock signals may be used. For example, in some designs a low voltage of a gate clock signal may be used to switch on the transistors of the display pixels, instead of a high voltage.

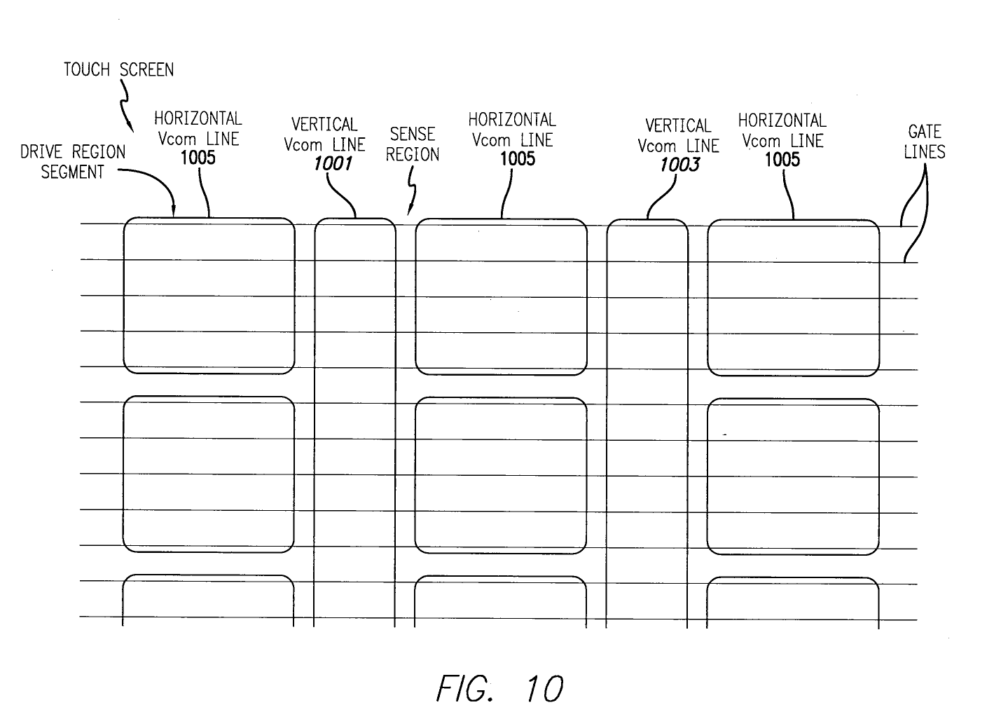

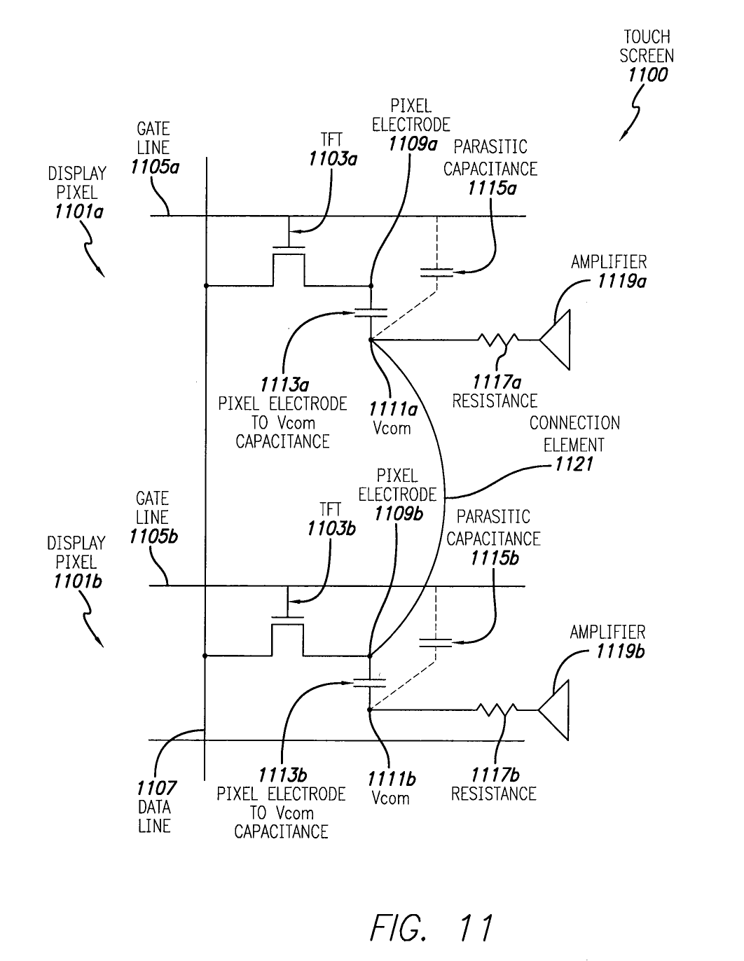

FIG. 9 illustrates an example partial circuit diagram of one display pixel 900 according to various embodiments. Some of the circuit elements of display pixel 900 can include a transistor (TFT) 901, a gate line 903, a data line 905, a pixel electrode 907, and a Vcom 909. Vcom 909 can be electrically connected to an amplifier 911 through a resistance 913. When gate line 903 is opened, for example, during a scan of the touch screen display, a high voltage of the gate signal can be applied to TFT 901, turning the gate of the TFT to the on state. A data signal on data line 905 can apply a voltage to pixel electrode 907, which can correspond to an amount of luminance required of the pixel to display the current frame of an image. The voltage applied by the data signal can be applied across a pixel electrode-to-Vcom capacitance 915 to create an electric field through liquid crystal (not shown) to activate the liquid crystal of the pixel to produce the desired amount of luminance. However, when the gate signal transitions from the high voltage to the low voltage, a kickback voltage can result across electrode 915. The kickback voltage can affect the luminance of the pixel, for example, by causing a decrease in the luminance from the desired luminance of the pixel. In some designs, a parasitic capacitance 917 can exist between gate line 903 and Vcom 909. For example, parasitic capacitance 917 can depend on the orientation and the amount of overlap between gate line 903 and Vcom 909 within the stack up of the display pixel. In some designs, the amount of kickback voltage, and therefore the effect on luminance, of each display pixel may be the same or similar. However, in some embodiments the kickback voltage may vary depending on the position of the display pixel in the touch screen layout.

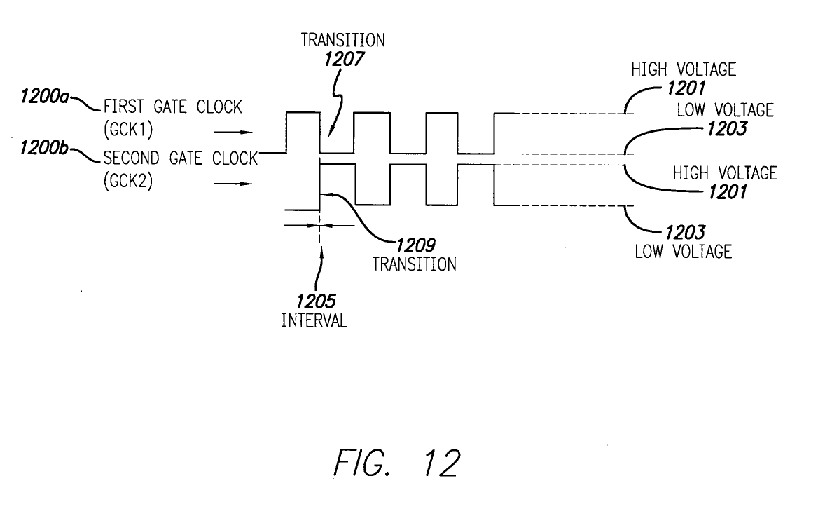

FIG. 10 illustrates another view of example touch screen 550 according to various embodiments. In FIG. 5 the common electrodes 509 of sense region 517 can be connected together with connection element 511. Therefore, the Vcoms in each sense region 517 form an electrically connected together structure that is represented in FIG. 10 as vertical Vcom line 1001 and vertical Vcom line 1003. Vertical Vcom lines 1001 and 1003 can be electrically separated from each other. Vcoms 509 of drive region segments 515 can be connected together with connection elements 511. In addition, the connected together Vcoms in each drive region segment can be further connected together through tunnel lines 519 to form an electrically connected together structure represented in FIG. 10 as horizontal Vcom line 1005. While vertical Vcom lines 1001 and 1003 can be electrically separated from each other, the segments that make up horizontal Vcom line 1005 can be electrically connected together via tunnel lines 519.

Referring again to FIG. 9, parasitic capacitance 917 can depend on, for example, an amount of overlap of gate line 903 with Vcom 909. In the example in embodiment illustrated in FIG. 10, it can be seen that the amount of overlap between a gate line 518 and horizontal Vcom line 1005 can be much greater than an amount of overlap between the gate line and vertical Vcom line 1001, for example. In other words, the parasitic capacitance between a gate line and the Vcom in a pixel in drive region segment 515 can be much greater than the parasitic capacitance in a display pixel in a sense region 517 of touch screen 550. The difference in the parasitic capacitances of display pixels in the drive regions and in the sense regions can cause a difference in the effective kickback voltages in each of the regions. The difference in kickback voltages can result in, for example, a difference in the luminance of pixels in the drive regions and of pixels in the sense regions of touch screen 550.

FIG. 11 illustrates an example partial circuit diagram of two display pixels in an example touch screen 1100 according to various embodiments. The two display pixels can be, for example, two display pixels in adjacent rows of drive region segment 515, two display pixels in adjacent rows of sense region 517, etc. A display pixel 1101a can include a TFT 1103a, a gate line 1105a, a data line 1107, a pixel electrode 1109a, a Vcom 1111a, a pixel electrode-to-Vcom capacitance 1113a, a parasitic capacitance 1115a, a resistance 1117a, and an amplifier 1119a. Likewise, display pixel 1101b can include a TFT 1103b, a gate line 1105b, a data line 1107, a pixel electrode 1109b, a Vcom 1111b, a pixel electrode-to-Vcom capacitance 1113b, a parasitic capacitance 1115b, a resistance 1117b, and an amplifier 1119b. For example, touch screen 1100 can correspond to touch screen 550 of FIG. 5, and the various elements in FIG. 11, such as gate lines, data lines, pixel electrodes, etc., can correspond to the same elements in touch screen 550. Likewise, a connection element 1121 of FIG. 11 can correspond to connection element 511 of FIG. 5. Connection element 1121 can electrically connect together Vcom 1111a and Vcom 1111b of touch screen 1100, such that Vcoms 1111a and 1111b can form a single conductive circuit element. In other words, display pixel 1101a and display pixel 1101b can be display pixels in adjacent rows of display pixels of an integrated touch screen that includes connected together Vcoms of display pixels to form drive region segments and sense regions such as those shown in FIGS. 5, 10, etc.

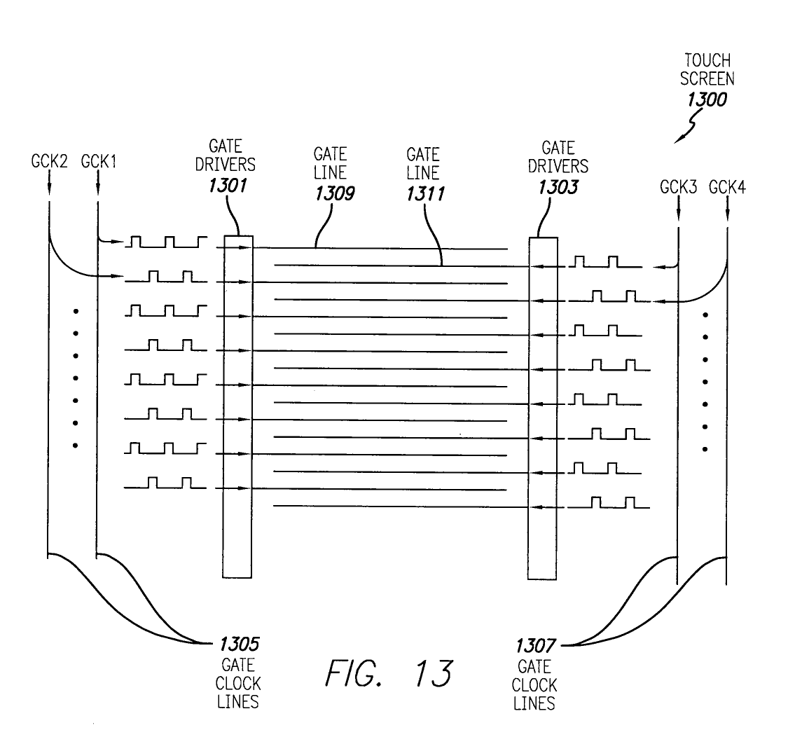

FIG. 12 illustrates example gate clock signals according to various embodiments. In this example, the gate clock signals GCK1 and GCK2 can include a high voltage 1201 and a low voltage 1203. In this example, an interval 1205 between a high voltage to low voltage transition 1207 of GCK1 and a low voltage to high voltage transition 1209 of GCK2 can be substantially zero. Referring to the partial circuit diagram of FIG. 11, an operation according to one example embodiment will now be described. First gate clock signal 1200a can be applied to gate line 1105a to switch TFT 1103a of display pixel 1101a to an on state. After a corresponding data signal is transmitted on data line 1107, transition 1207 of GCK1 can switch TFT 1103a to an off state while transition 1209 of GCK2 applied along gate line 1105b can switch TFT 1103b to an on state at approximately the same time, that is, within time interval 1205, which can be within a time period during which a voltage of Vcom 1111a is changed due to the effect of transition 1207 caused by capacitive coupling through parasitic capacitance 1115a. Low to high voltage transition 1209 can cause a corresponding change in the voltage of Vcom 1111b that can counteract the change in voltage of Vcom 1111a due to transition 1207. In other words, the counteracting voltage changes in the connected-together Vcoms 1111a and 1111b can result from the rising transition 1209 occurring while the voltage change of Vcom 1111a is occurring. As a result, a difference in parasitic capacitances between the Vcom lines and the gate lines in different regions of a touch screen may be reduced or eliminated. In integrated touch screens such as touch screen 1100, this may have a further benefit of reducing a difference the luminances of display pixels in drive regions and display pixels in sense regions.

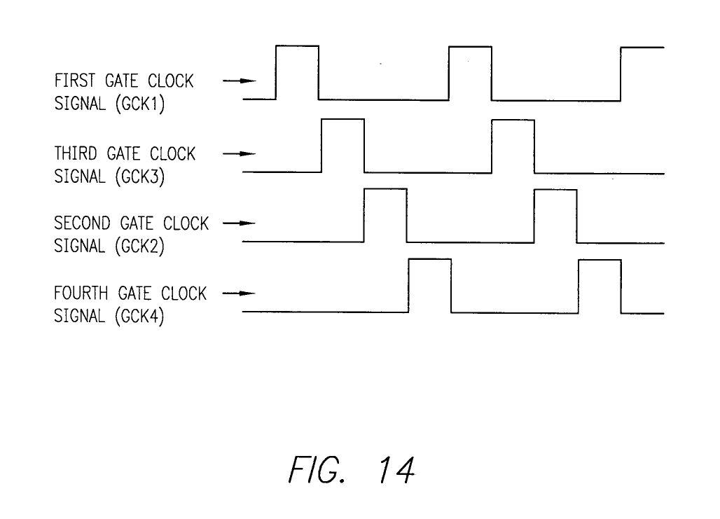

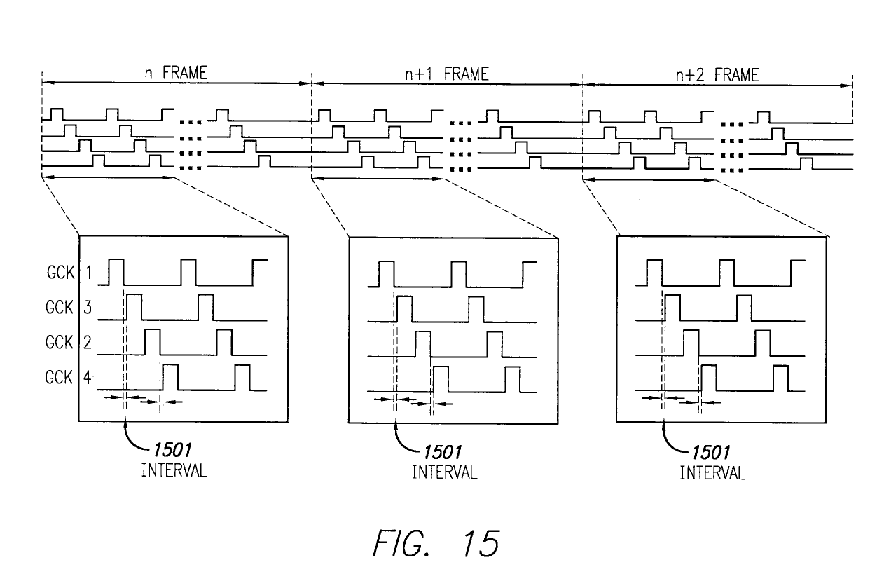

The first gate clock signal 1200a and second gate clock signal 1200b may be applied to the gate lines using a single-sided gate driver arrangement such as that shown in FIG. 7. However, as described above, in some designs a simultaneous or near simultaneous high to low transition and low to high transition of sequential gate clock signals can require more power. FIG. 13 illustrates an example configuration of gate drivers according to various embodiments in which a double-sided gate driver configuration can be used. FIG. 13 shows a touch screen 1300 including two sets of gate drivers, gate drivers 1301 and 1303, on either side of the active area of touch screen 1300. Gate drivers 1301 can receive gate clock signals from gate clock lines 1305, and gate drivers 1303 can receive gate clock signals from gate clock lines 1307. FIG. 14 illustrates an example set of gate clock signals including first, second, third and fourth gate clock signals, GCK1, GCK2, GCK3, GCK4, respectively. As shown in FIG. 13, gate signals based on gate clock signals GCK1 and GCK2 can be applied by gate drivers 1301 to gate lines 1309 from the left side of the touch screen 1300, and gate signals based on GCK3 and GCK4 can be applied by gate drivers 1303 to gate lines 1311 from the right side of the touch screen. As gate lines 1309 and 1311 are scanned sequentially from top to bottom, the order of the gate clock signals can be, for example, GCK1 from gate driver 1301, GCK3 from gate driver 1303, GCK2 from gate driver 1301, GCK4 from gate driver 1303, etc. This pattern can repeat for the remainder of the gate lines in the touch screen. In this way, for example, the falling and rising conditions of adjacent gate clock signals on adjacent gate clock lines can be aligned to be simultaneous or nearly simultaneous when applied to the gate lines, yet at the same time the rising and falling transitions of the gate clock signals in each gate clock line pair 1305 and 1307 need not occur simultaneously. Because the transitions in the gate clock signals in each gate clock line pair do not overlap, the power required to drive the gate clock lines may be less in this example embodiment.

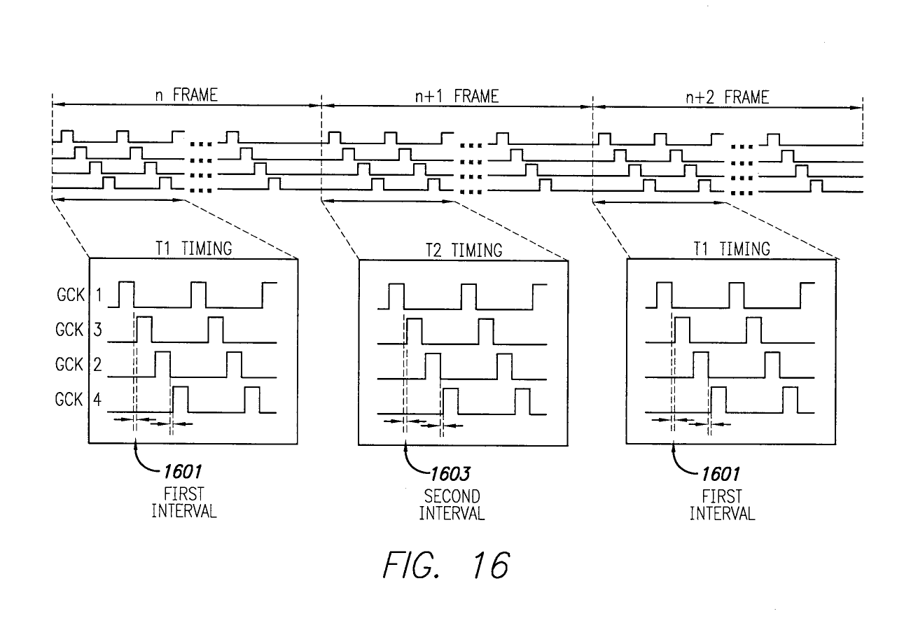

FIG. 15 illustrates an example method of setting the intervals according to various embodiments. FIG. 15 shows three representative frames or complete scans of display pixel rows in an example touch screen with a double-sided gate driver design such as illustrated in FIG. 13. The three sequential frames are shown in FIG. 15 as an n frame, an n+1 frame, and an n+2 frame. FIG. 15 shows a sequence of gate clock signals, GCK1, GCK3, GCK2, and GCK4, similar to the sequence shown in FIG. 14, for example. In the example embodiment of FIG. 15, a fixed time interval 1501 can be selected for each of the intervals between the rising and falling transitions of each gate clock signal in each sequential frame. Fixed time interval 1501 may be chosen by, for example, simulation testing that can determine the ideal or preferable time interval that yields a minimum in luminance difference between the various regions of the touch screen. In some cases, simulation testing may not yield accurate results for differences in luminance. In these cases, the designer might choose to have the touch screen fabricated as prototypes, and then empirically test the prototypes to determine an ideal or suitable time interval to achieve a reduced differences in luminances. In these cases, it may be desirable for the designer to set a range of time intervals, for example, that can be adjustable in firmware of the touch screen. As an example, the range may be from 0 to 100 nanoseconds. In this way a designer may have prototype touch screens manufactured, receive the prototypes, and use empirical testing to determine a time interval. The time interval can be adjustable via firmware, for example, and the designer can then set a fixed time interval for the final product.

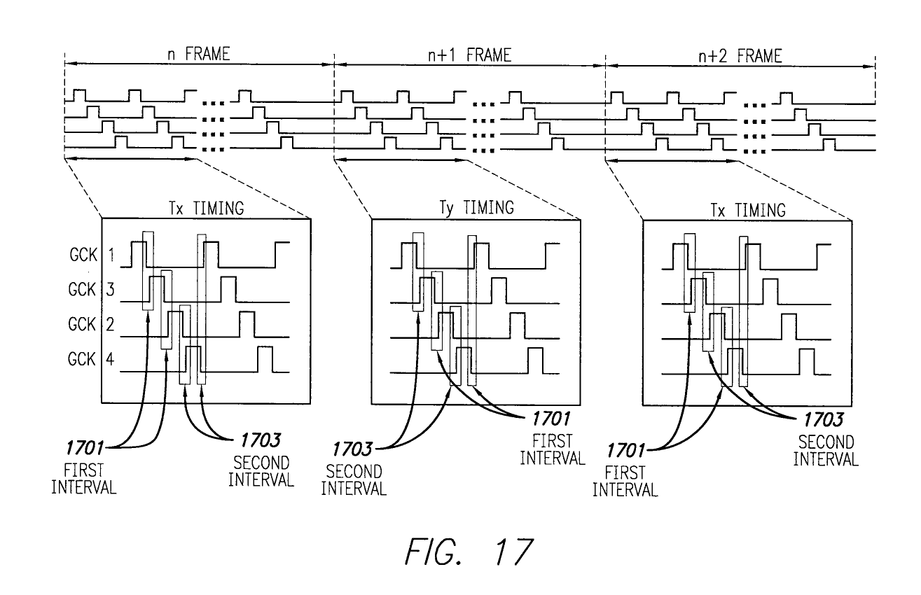

FIG. 16 illustrates another example method of setting the interval according to various embodiments. FIG. 16 shows three sequential frames, an n frame, an n+1 frame, and an n+2 frame. In this example embodiment, a designer may select two discrete time intervals, for example, a first interval 1601 and a second interval 1603. In a first frame, for example the n frame, first interval 1601 may be used as the interval of the gate clock signals. In the next frame, for example, the n+1 frame, second interval 1603 may be used for the gate clock signal interval. In the third frame, for example the n+2 frame, first interval 1601 may again be used for the interval of the gate clock signals. In this way, two discrete values of intervals may be, in effect, averaged by alternating frames. In other words, the gate clock signals can be altered from frame to frame, such that the intervals alternate between two discrete time intervals. At a sufficiently high frame rate, the human eye can effectively average between the two different luminances that may occur as a result of each time interval, which may result in an overall reduction of visual artifacts caused by differences in luminance. Of course, one skilled in the art will readily understand that different combinations of timing and frames can be used. For example, the ratio of frames used for each interval can be something other than 1:1. For example, a first discrete interval can be used for two frames out of every one frame in which the second interval is used, for a ratio of 2:1 for the first interval to the second interval, for example. Of course, higher ratios such as 4:1, 5:1, etc. may be used. More than two time intervals may be used, for example, three or more distinct time intervals may be used in various ratios to achieve an averaging effect.

FIG. 17 illustrates another example method of selecting intervals according to various embodiments. As in the previous two example embodiments, FIG. 17 illustrates three example sequential frames, an n frame, an n+1 frame, and an n+2 frame. In this example embodiment, different time intervals can be used from line to line (e.g., row of display pixels to row of display pixels) within a single frame, that is, within a single top to bottom scan of the touch screen. For example, in the n frame FIG. 17 shows a first interval 1701 between a high to low transition of GCK1 and a low to high transition of GCK3, a second interval 1703 between a high to low transition of GCK3 and a low to high transition of GCK2, the first interval 1701 between a high to low transition of GCK2 and a low to high transition of GCK4 and the second interval 1703 between a high to low transition of GCK4 and a low to high transition of GCK1. As the gate clock signals are applied sequentially in the order shown, a kickback voltage resulting on gate lines stimulated with GCK1 and GCK2 can be reduced based on the first time interval 1701 when GCK3 and GCK4, respectively, are applied to the next gate lines in sequence. Likewise, a kickback voltage on gate lines stimulated with GCK3 and GCK4 can be mitigated or reduced based on the second interval 1703 when GCK1 and GCK2, respectively, are applied to the next gate lines in the sequence. Consequently, averaging similar to the frame by frame averaging of the embodiment shown in FIG. 16 can be implemented on a line by line basis in the present embodiment. This line by line averaging shown in the n frame of FIG. 17 can be repeated for each frame in some embodiments.

FIG. 17 shows an additional embodiment in which the gate clock signals can be modified frame by frame to include different configurations of the intervals. For example, in the n+1 frame shown in FIG. 17, the order of the intervals between high to low and low to high transitions of GCK1, GCK3, GCK2, and GCK4, is modified from the n frame order. In particular, the GCK1 to GCK3 and the GCK2 to GCK4 transitions are at the second interval 1703, and the GCK3 to GCK2 and the GCK4 to GCK1 transitions are at the first interval 1701 in the n+1 frame example of FIG. 17. In the n+2 frame, the configuration of intervals returns to the n frame configuration, and the pattern can then repeat frame to frame between the first configuration and the second configuration of time intervals. In other words, the example embodiment shown in FIG. 17 can include both line to line averaging of intervals and frame to frame averaging of intervals, along with the corresponding averaging of the luminance effects of the different discrete intervals selected by the designer.

Another strategy for reducing a luminance difference between regions of a touch screen due to kickback voltages can include increasing the falling time of one or more of the gate line signals, that is, slowing the rate that gate line signal goes from high to low. This strategy can allow the Vcom more time to recover and stabilize from the high to low transition, which can be particularly helpful in embodiments in which the Vcoms in different regions of the touch screen are associated with different circuit properties. For example, in some embodiments, the gate lines can be clamped to a fixed voltage during a touch sensing phase, but the resistances associated with the clamping can be different in the drive and sense regions, which can result in a difference in the time it takes each region to recover from kickback voltages. Slowing the falling gate line can reduce the difference in recovery time by allowing slower regions more time to recover, such that a difference between the Vcom voltages of the two regions can be reduced.

Although embodiments of this disclosure have been fully described with reference to the accompanying drawings, it is to be noted that various changes and modifications including, but not limited to, combining features of different embodiments, omitting a feature or features, etc., as will be apparent to those skilled in the art in light of the present description and figures.

For example, one or more of the functions of computing system 200 described above can be performed by firmware stored in memory (e.g. one of the peripherals 204 in FIG. 2) and executed by touch processor 202, or stored in program storage 232 and executed by host processor 228. The firmware can also be stored and/or transported within any computer-readable medium for use by or in connection with an instruction execution system, apparatus, or device, such as a computer-based system, processor-containing system, or other system that can fetch the instructions from the instruction execution system, apparatus, or device and execute the instructions. In the context of this document, a “computer-readable medium” can be any medium that can contain or store the program for use by or in connection with the instruction execution system, apparatus, or device. The computer readable medium can include, but is not limited to, an electronic, magnetic, optical, electromagnetic, infrared, or semiconductor system, apparatus or device, a portable computer diskette (magnetic), a random access memory (RAM) (magnetic), a read-only memory (ROM) (magnetic), an erasable programmable read-only memory (EPROM) (magnetic), a portable optical disc such a CD, CD-R, CD-RW, DVD, DVD-R, or DVD-RW, or flash memory such as compact flash cards, secured digital cards, USB memory devices, memory sticks, and the like.

The firmware can also be propagated within any transport medium for use by or in connection with an instruction execution system, apparatus, or device, such as a computer-based system, processor-containing system, or other system that can fetch the instructions from the instruction execution system, apparatus, or device and execute the instructions. In the context of this document, a “transport medium” can be any medium that can communicate, propagate or transport the program for use by or in connection with the instruction execution system, apparatus, or device. The transport readable medium can include, but is not limited to, an electronic, magnetic, optical, electromagnetic or infrared wired or wireless propagation medium.

Example embodiments may be described herein with reference to a Cartesian coordinate system in which the x-direction and the y-direction can be equated to the horizontal direction and the vertical direction, respectively. However, one skilled in the art will understand that reference to a particular coordinate system is simply for the purpose of clarity, and does not limit the direction of the elements to a particular direction or a particular coordinate system. Furthermore, although specific materials and types of materials may be included in the descriptions of example embodiments, one skilled in the art will understand that other materials that achieve the same function can be used. For example, it should be understood that a “metal layer” as described in the examples below can be a layer of any electrically conductive material.

In some embodiments, the drive lines and/or sense lines can be formed of other elements including, for example other elements already existing in typical LCD displays (e.g., other electrodes, conductive and/or semiconductive layers, metal lines that would also function as circuit elements in a typical LCD display, for example, carry signals, store voltages, etc.), other elements formed in an LCD stackup that are not typical LCD stackup elements (e.g., other metal lines, plates, whose function would be substantially for the touch sensing system of the touch screen), and elements formed outside of the LCD stackup (e.g., such as external substantially transparent conductive plates, wires, and other elements). For example, part of the touch sensing system can include elements similar to known touch panel overlays.

In this example embodiment, each sub-pixels can be a red (R), green (G) or blue (B) sub-pixel, with the combination of all three R, G and B sub-pixels forming one color display pixel. Although this example embodiment includes red, green, and blue sub-pixels, a sub-pixel may be based on other colors of light or other wavelengths of electromagnetic radiation (e.g., infrared) or may be based on a monochromatic configuration.

What is claimed is:

1. A gate driver system of a touch screen, comprising:
a plurality of gate lines connected to display pixel transistors;
a display driver that generates first and second gate clock signals including first and second voltage transitions, respectively; and
a plurality of gate drivers that receive the first and second gate clock signals via gate clock lines and that apply gate line signals, based on the gate clock signals, to the gate lines, wherein a first voltage change generated in a common electrode line of the touch screen by the first voltage transition is reduced by a second voltage change generated in the common electrode by the second voltage transition.

2. The gate driver system of claim 1, wherein a first time interval between the first and second voltage transitions is based on a first time interval value.

3. The gate driver system of claim 2, wherein the plurality of gate drivers includes a first set of gate drivers positioned at a first side of an active area of the touch screen, and a second set of gate drivers positioned at a second side of the active area opposite the first side, the display driver generates third and fourth gate clock signals including third and fourth voltage transitions, respectively, the gate drivers in the first set receive the first and third gate clock signals, and the gate drivers in the second set receive the second and fourth gate clock signals.

4. The gate driver system of claim 3, wherein time intervals between the third and fourth voltage transitions are based on one of the first time interval value and a second time interval value different from the first time interval value.

5. The gate driver system of claim 4, wherein one or both of the first and second time interval values is a fixed value that is based on a hardware design of the gate driver system.

6. The gate driver system of claim 4, wherein one or both of the first and second time interval values is stored in a computer-readable storage memory of the touch screen and is adjustable within a predetermined range of values.

7. The gate driver system of claim 4, wherein all of the time intervals of a first frame of a display operation of the touch screen are based on the first time interval value, and all of the time intervals of a second frame are based on the second time interval value.

8. The gate driver system of claim 7, wherein the display operation includes repeatedly alternating between a number of first frames and a number of second frames based on a predetermined ratio of first frames to second frames.

9. The gate driver system of claim 4, wherein the time intervals of a first frame of a display operation are based on the first and second time interval values in a predetermined ratio.

10. The gate driver system of claim 3, wherein a third voltage change generated in the common electrode line of the touch screen by the third voltage transition is reduced by a fourth voltage change generated in the common electrode by the fourth voltage transition.

11. A method of scanning gate lines during a display operation of a touch screen, the touch screen including a common electrode line capacitively coupled to first and second gate lines of the touch screen, the method comprising:
applying, to the first gate line, a first gate signal that generates a first voltage change in the common electrode line; and
applying, to the second gate line, a second gate signal that generates a second voltage change that reduces the first voltage change in the common electrode line.

12. The method of claim 11, wherein the first gate signal is based on a first gate clock signal that includes a high-to-low voltage transition that switches a state of display pixel transistors connected to the first gate line, and the second gate signal is based on a second gate clock signal that includes a low-to-high voltage transition that switches the state of display pixel transistors connected to the second gate line.

13. The method of claim 12, wherein the high-to-low and low-to-high voltage transitions occur within an interval of 100 nanoseconds.

14. The method of claim 12, further comprising:
setting a time interval between the high-to-low and low-to-high voltage transitions to a first time interval during a first frame of the display operation, and setting the time interval to a second time interval, different than the first time interval, during a second frame of the display operation.

15. The method of claim 14, wherein setting the time intervals includes setting the first and second time intervals to alternate repeatedly based on a predetermined ratio of frames.

16. The method of claim 12, further comprising:
setting a time interval between the high-to-low and low-to-high voltage transitions to a first time interval for the first and second gate line signals during a first frame of the display operation, and setting the time interval to a second time interval, different than the first time interval, for a third and a fourth gate signals during the first frame.

17. The method of claim 16, wherein setting the time intervals includes setting the first and second time intervals to alternate repeatedly during the first frame based on a predetermined ratio of gate signal pairs.

18. A touch screen comprising:
a plurality of display pixels including
a first display pixel including a first transistor with a gate connected to a first gate line of a plurality of gate lines, a source connected to one of a plurality of data lines, and a drain connected to a first pixel electrode, the pixel electrode being capacitively coupled to a first common electrode line;
a second display pixel including a second transistor with a gate connected to a second gate line of the plurality of gate lines, a source connected to one of the plurality of data lines, and a drain connected to a second pixel electrode, the second pixel electrode being capacitively coupled to the first common electrode line, wherein the first common electrode line is capacitively coupled to the first and second gate lines;
a first gate driver that applies a first gate signal to the first gate line based on a first gate clock signal received from a first gate clock line, the first gate clock signal including a first voltage transition that switches the first transistor from an on state to an off state, wherein the first voltage transition generates a corresponding first voltage change in the first common electrode line for a first period of time; and
a second gate driver that applies a second gate signal to the second gate line based on a second gate clock signal received from a second gate clock line, the second gate clock signal including a second voltage transition that switches the second transistor from an off state to an on state, wherein the second gate clock signal is timed such that the second voltage transition generates a corresponding second voltage change in the first common electrode line during the first time period.

19. The touch screen of claim 18, wherein the first gate driver and the first gate clock line are positioned at opposite sides of an active area of the touch screen from the second gate driver and the second gate clock line.
